(19) United States
(12) Patent Application Publication
(10) Pub. No.: US 2012/0180493 A1
(43) Pub. Date: Jul. 19, 2012

(54) APPARATUS AND METHOD FOR CONTROLLING OXYGEN EMISSIONS FROM A GAS TURBINE

(75) Inventors: Daniel David Snook, Moore, SC (US); Andrew Mitchell Rodwell, Greenville, SC (US)

(73) Assignee: GENERAL ELECTRIC COMPANY, Schenectady, NY (US)

(21) Appl. No.: 13/005,930

(22) Filed: Jan. 13, 2011

(51) Int. Cl. F02C 1/00; F02C 7/08

(52) U.S. Cl. 60/772; 60/39.5

(57) ABSTRACT

A combined cycle power plant includes a first compressor that produces a compressed working fluid and a turbine downstream of the first compressor. The turbine includes stationary components and rotating components and produces an exhaust. A heat exchanger downstream of the turbine receives the exhaust from the turbine, and a second compressor downstream of the heat exchanger and upstream of the turbine receives the exhaust from the heat exchanger and provides a flow of exhaust to the turbine. A method for reducing oxygen emissions from a gas turbine includes flowing an exhaust from a turbine to a heat exchanger and removing heat from the exhaust. The method further includes increasing the pressure of the exhaust to produce a pressurized exhaust and flowing the pressurized exhaust back to the turbine to remove heat from the turbine.

### FIELD OF THE INVENTION

The present invention generally involves an apparatus and method for controlling oxygen emissions from a gas turbine. In particular, various embodiments of the present invention provide an apparatus and method for controlling oxygen emissions from a gas turbine in a combined cycle power plant.

### BACKGROUND OF THE INVENTION

A combined cycle power plant often includes one or more gas turbines for power generation. A typical gas turbine includes a compressor at the front, one or more combustors around the middle, and a turbine at the rear. The compressor imparts kinetic energy to the working fluid (e.g., air) to bring it to a highly energized state. A compressed working fluid exits the compressor and flows to the combustors where it mixes with fuel and combusts to generate combustion gases having a high temperature and pressure. The combustion gases flow to the turbine where they expand to produce work. The combustion process removes a substantial amount of the oxygen present in the compressed working fluid. As a result, the exhaust gases exiting the turbine typically have low levels of oxygen.

The thermodynamic efficiency of the gas turbine increases as the operating temperature, namely the combustion gas temperature, increases. Specifically, higher temperature combustion gases contain more energy and produce more work as the combustion gases expand in the turbine. However, higher temperature combustion gases may produce excessive temperatures in the turbine that can approach or exceed the melting temperature of various turbine components. To reduce the temperatures in the turbine, air may be extracted from the compressor, bypassed around the combustors, and injected into the turbine. The extracted air may be injected directly into the stream of combustion gases and/or circulated through the interior of the turbine components to provide conductive and/or convective cooling to the turbine stages.

The extracted air that bypasses the combustors to cool the turbine components reduces the volume of combustion gases produced by the combustors, thus reducing the overall output and efficiency of the gas turbine. In addition, the extracted air eventually merges with the combustion gases flowing through the turbine, increasing the oxygen levels in the exhaust gases exiting the turbine. The increased levels of oxygen in the exhaust gases exiting the turbine may create a problem for auxiliary systems that receive the exhaust gases. Reducing the level of oxygen in the exhaust can be advantageous to downstream emissions control equipment and where the exhaust gases are used in other industrial processes that require reduced oxygen. As a result, a cooling system that can remove heat from the turbine components without increasing the oxygen content of the exhaust gases exiting the turbine would be useful.

### BRIEF DESCRIPTION OF THE INVENTION

Aspects and advantages of the invention are set forth below in the following description, or may be obvious from the description, or may be learned through practice of the invention.

One embodiment of the present invention is a combined cycle power plant that includes a first compressor that produces a compressed working fluid and a turbine downstream of the first compressor. The turbine includes stationary components and rotating components and produces an exhaust. A heat exchanger downstream of the turbine receives the exhaust from the turbine, and a second compressor downstream of the heat exchanger and upstream of the turbine receives the exhaust from the heat exchanger and provides a flow of exhaust to the turbine.

Another embodiment of the present invention is a combined cycle power plant that includes a first compressor that produces a compressed working fluid and a turbine downstream of the first compressor. The turbine includes a plurality of stators and produces an exhaust. A rotor is connected to the turbine, and the rotor includes a plurality of cavities. A heat exchanger downstream of the turbine receives the exhaust from the turbine, and a second compressor downstream of the heat exchanger and upstream of the turbine receives the exhaust from the heat exchanger and provides a flow of exhaust to the turbine.

The present invention also includes a method for reducing oxygen emissions from a gas turbine. The method includes flowing an exhaust from a turbine to a heat exchanger and removing heat from the exhaust. The method further includes increasing the pressure of the exhaust to produce a pressurized exhaust and flowing the pressurized exhaust back to the turbine to remove heat from the turbine.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simplified block diagram of a combined cycle power plant according to one embodiment of the present invention;

FIG. 2 is a simplified cross-section of a turbine according to one embodiment of the present invention; and

FIG. 3 is a simplified cross-section of a turbine according to an alternate embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

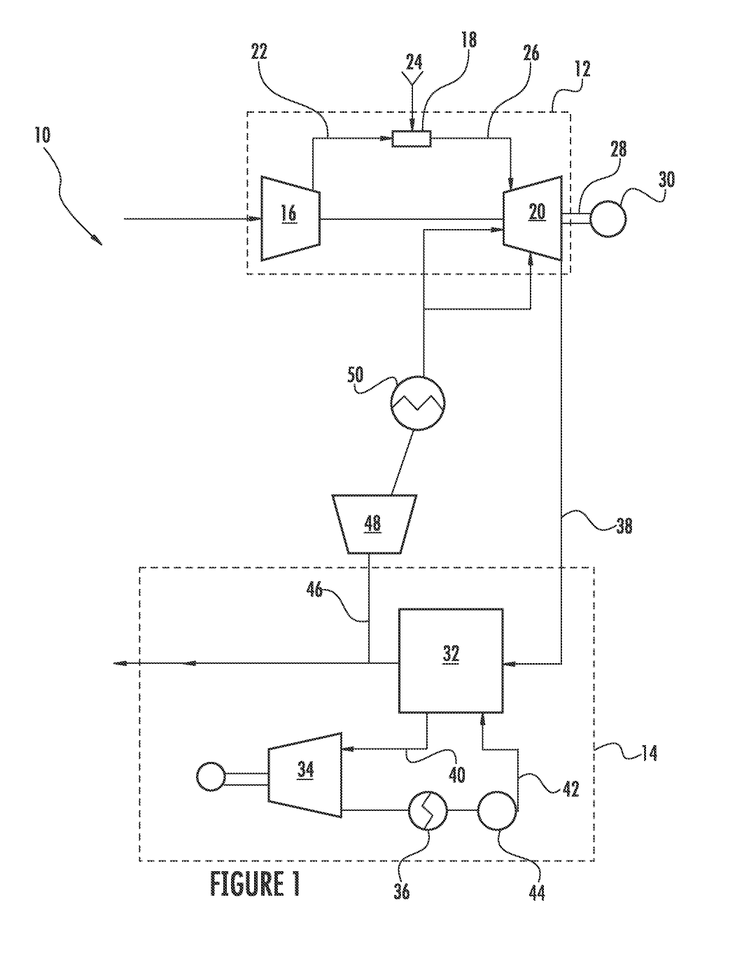

Various embodiments of the present invention provide a combined cycle power plant and method for reducing oxygen emissions from a gas turbine. For example, FIG. 1 shows a simplified block diagram of a combined cycle power plant 10 according to one embodiment of the present invention. The combined cycle power plant 10 generally includes a gas turbine 12 connected to a heat recovery system 14 as is known in the art. For example, as shown in FIG. 1, the gas turbine 12 includes a first compressor 16, at least one combustor 18 downstream of the first compressor 16, and a turbine 20 downstream of the combustor 18. As used herein, the terms “upstream” and “downstream” refer to the relative location of components in a fluid pathway. For example, component A is upstream of component B if a fluid flows from component A to component B. Conversely, component B is downstream of component A if component B receives a fluid flow from component A. The first compressor 16 produces a compressed working fluid 22 which flows to the combustor 18. The combustor 18 generally combines the compressed working fluid 22 with a supply of fuel 24 and/or diluent and ignites the mixture to produce combustion gases 26. The supplied fuel 24 may be any suitable fuel used by commercial combustion engines, such as blast furnace gas, coke oven gas, natural gas, vaporized liquefied natural gas (LNG), propane, and any form of liquid fuel. The diluent may be any fluid suitable for diluting or cooling the fuel, such as compressed air, steam, nitrogen, or another inert gas. The combustion gases 26 flow to the turbine 20 where they expand to produce work. For example, expansion of the combustion gases 26 in the turbine 20 may rotate a shaft 28 connected to a generator 30 to produce electricity.

The heat recovery system 14 may be retrofitted or added to existing gas turbines to increase the overall thermodynamic efficiency of the gas turbine while also reducing oxygen emissions. The heat recovery system 14 may include, for example, a heat exchanger 32, such as a steam generator, a steam turbine 34, and a condenser 36. The heat exchanger or steam generator 32 may be located downstream from the turbine 20, and exhaust gases 38 from the turbine 20 may flow through the steam generator 32 to produce steam 40. The steam turbine 34 may be located downstream of the steam generator 32, and the steam 40 from the steam generator 32 expands in the steam turbine 34 to produce work. The condenser 36 may be located downstream of the steam turbine 34 and upstream of the steam generator 32 to condense the steam 40 exiting the steam turbine 34 into condensate 42 which is returned to the steam generator 32. One or more condensate pumps 44 between the condenser 36 and the steam generator 32 are in fluid communication with the steam generator 32 to provide the condensate 42 from the condenser 36 to the steam generator 32.

As shown in FIG. 1, a portion of the exhaust 46 exiting the steam generator 32 may be recirculated back through the turbine 20 to provide cooling to the turbine components. The recirculated exhaust 46 may flow through a second compressor 48 and a heat exchanger 50 to adjust the pressure and temperature of the recirculated exhaust 46 before flowing through the turbine 20. The oxygen level in the recirculated exhaust 46 will be substantially less than the oxygen level in the compressed working fluid 22 exiting the compressor 16. In some embodiments, the oxygen content of the recirculated exhaust 46 may be approximately 50%, 75%, or 90% less than the oxygen content of the compressed working fluid 22 exiting the compressor 16. Reduced oxygen emissions may thus be achieved by decreasing the oxygen content in the air used to cool the turbine 20.

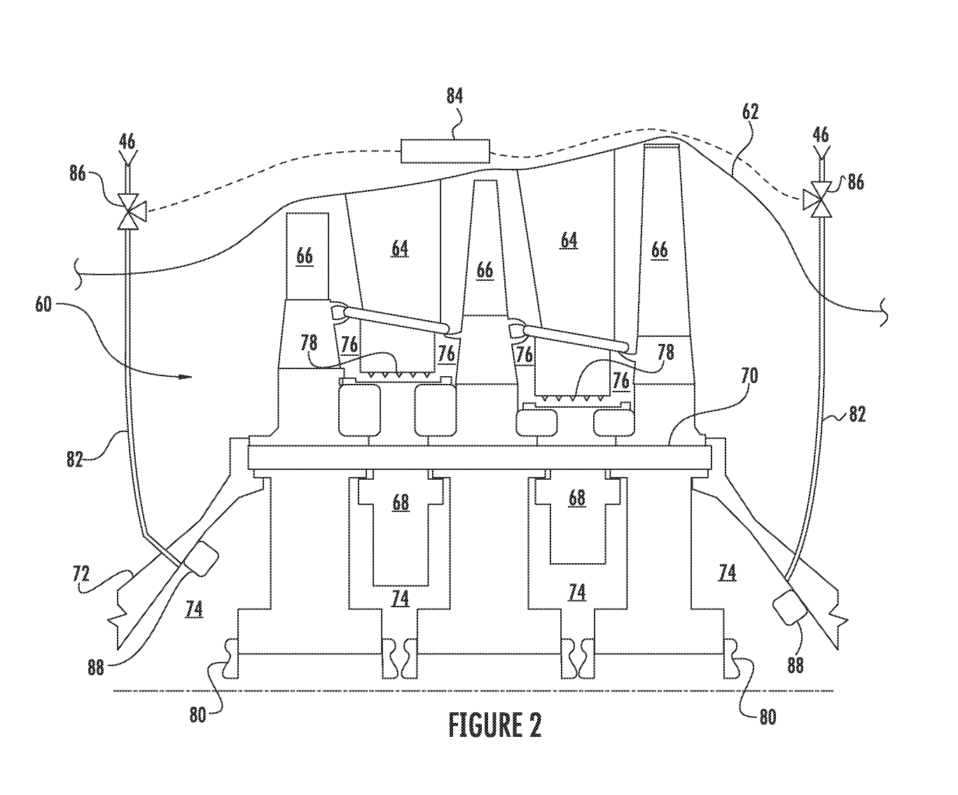

FIG. 2 provides a simplified cross-section of an exemplary turbine 60 according to one embodiment of the present invention. As shown in FIG. 2, the turbine 60 may include stationary and rotating components surrounded by a casing 62. The stationary components may include, for example, stationary nozzles or stators 64 attached to the casing 62. The rotating components may include, for example, rotating airfoils 66 and/or rotating spacers 68 attached by a bolt 70 to a rotor 72. The rotor 72 may include various cavities, referred to as rotor-rotor cavities 74 and rotor-stator cavities 76. A diaphragm seal 78 between the stators 64 and rotating spacers 68 may create a boundary for the rotor-stator cavities 76 that prevents or restricts flow between adjacent rotor-stator cavities 76. Similarly, a barrier 80 at the interior of the rotor 72 prevents or restricts flow between adjacent rotor-rotor cavities 74 within the rotor 72. The combustion gases 26 from the combustors 18 flow along a hot gas path through the turbine 20 from left to right as shown in FIG. 2. As the combustion gases 26 pass over the first stage of airfoils 66, the combustion gases 26 expand, causing the airfoils 66, spacers 68, bolt 70, and rotor 72 to rotate. The combustion gases 26 then flow across the stators 64 which redirect the combustion gases 26 to the next row of rotating airfoils 66, and the process repeats for the following stages.

As shown in FIG. 2, a plenum 82 may connect to either or both sides of the rotor 72 to provide fluid communication for the recirculated exhaust 46 to pass into and/or through the rotor 72 and other rotating components. A controller 84 may direct the positioning of control valves 86 in the plenum 82 to regulate the flow of the recirculated exhaust 46 into and/or through the rotor-rotor cavities 74. The recirculated exhaust 46 may purge the rotor-rotor cavities 74 of any hot combustion gases 26 and provide cooling to the rotor-rotor cavities 74 and other rotating components such as the rotating airfoils 66, thereby cooling the rotating components of the turbine 20. In addition, any recirculated exhaust 46 that leaks into the hot gas path will not increase the oxygen content of the turbine exhaust 38.

The controller 84 may receive signals from any of multiple sources to determine the appropriate positions of the control valves 86 to achieve the desired cooling to the rotating components. For example, the rotor 72 may include sensors 88 in the rotor-rotor cavities 74. The sensors 88 may send a signal to the controller 84 reflective of a pressure or temperature in the rotor-rotor cavities 74, and the controller 84 may then adjust the position of the control valves 86 to achieve a desired pressure or temperature in the rotor-rotor cavities 74. In still further embodiments, the controller 84 may receive a signal reflective of the operating level of the compressor 16, combustors 18, or turbine 20 and adjust the control valves 86 according to a pre-programmed schedule to achieve the desired cooling for the turbine 20 for a given power level.

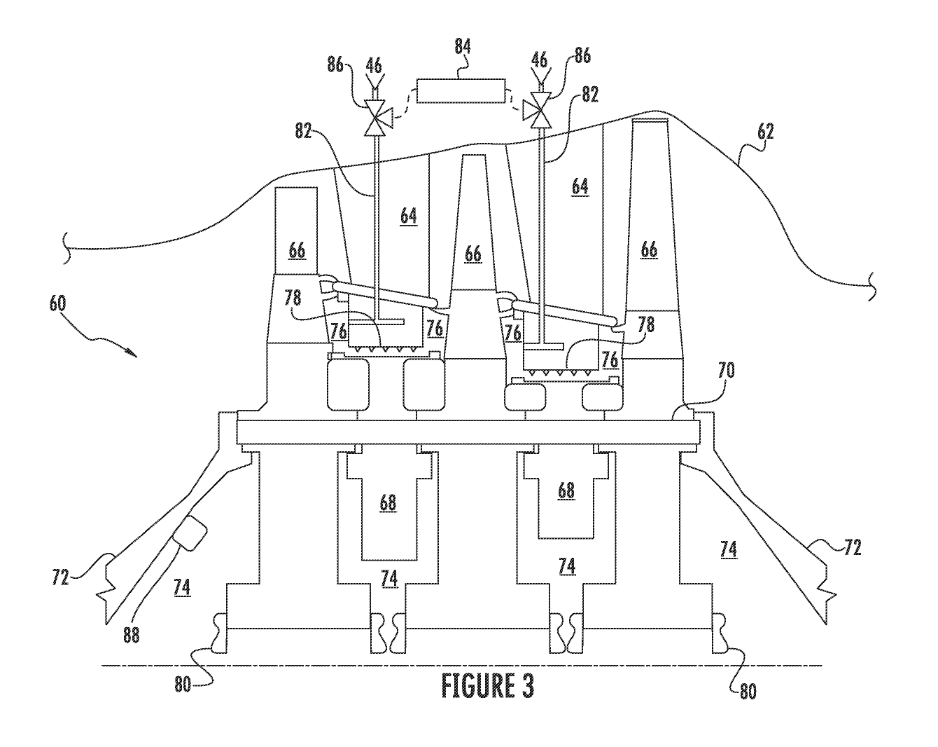

FIG. 3 provides a simplified cross-section of the exemplary turbine 60 shown in FIG. 2 according to an alternate embodiment of the present invention. The components of the turbine 60 are as previously described with respect to FIG. 2. In this embodiment, the recirculated exhaust 46 passes through the casing 62 and stators 64 to provide the recirculated exhaust 46 to the stationary components of the turbine 20, such as the stators 64 and/or rotor-stator cavities 76. The controller 84 again directs the positioning of the control valves 86 in each plenum 82 to regulate the flow of the recirculated exhaust 46. The recirculated exhaust 46 purges the rotor-stator cavities 76 of any hot combustion gases 26, prevents any high temperature combustion gases 26 from entering the rotor-stator cavities 76 during operations, and provides cooling to the stators 64 and/or rotor-stator cavities 76, thereby cooling the stationary components of the turbine 20.

As previously discussed with respect to the embodiment shown in FIG. 2, the controller 84 may receive signals from any of multiple sources, such as the operating level of the compressor 16, combustors 18, or turbine 20, to determine the appropriate positions of the control valves 86 to achieve the cooling for the turbine 20.

The embodiments described and illustrated in FIGS. 1-3 may also provide a method for reducing oxygen emissions from the gas turbine 12. The method may include flowing the exhaust 38 from the turbine 20 to the heat exchanger 32 and removing heat from the exhaust 38. The method may further include increasing the pressure of the exhaust 38 to produce the recirculated or pressurized exhaust 46 and flowing the pressurized exhaust 46 back to the turbine 20 to remove heat from the turbine 20. In particular embodiments, the method may control the flow of the pressurized exhaust 46 to rotating or stationary components in the turbine 20 according to a temperature, pressure, or power level of the gas turbine 12.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A power plant comprising:
a. a first compressor, wherein the first compressor produces a compressed working fluid;
b. a turbine downstream of the first compressor, wherein the turbine comprises stationary components and rotating components, and wherein the turbine produces an exhaust;
c. a heat exchanger downstream of the turbine, wherein the heat exchanger receives the exhaust from the turbine;
d. a second compressor downstream of the heat exchanger and upstream of the turbine, wherein the second compressor receives the exhaust from the heat exchanger and provides a flow of exhaust to the turbine.

2. The power plant as in claim 1, wherein the second compressor provides the flow of exhaust to the stationary components in the turbine.

3. The power plant as in claim 1, wherein the second compressor provides the flow of exhaust to the rotating components in the turbine.

4. The power plant as in claim 1, further comprising a control valve downstream of the second compressor and upstream of the turbine, wherein the control valve regulates the flow of exhaust to at least one of the stationary or rotating components.

5. The power plant as in claim 4, wherein the control valve regulates the flow of exhaust according to a pressure or a temperature.

6. The power plant as in claim 4, wherein the control valve regulates the flow of exhaust according to a power level of at least one of the first compressor or turbine.

7. The power plant as in claim 1, wherein the flow of exhaust provided to the turbine from the second compressor has an oxygen content at least approximately 50% less than an oxygen content of the compressed working fluid.

8. The power plant as in claim 1, wherein the flow of exhaust provided to the turbine from the second compressor has an oxygen content at least approximately 75% less than an oxygen content of the compressed working fluid.

9. A power plant comprising:
a. a first compressor, wherein the first compressor produces a compressed working fluid;
b. a turbine downstream of the first compressor, wherein the turbine includes a plurality of stators and produces an exhaust;
c. a rotor connected to the turbine, wherein the rotor includes a plurality of cavities;
d. a heat exchanger downstream of the turbine, wherein the heat exchanger receives the exhaust from the turbine;
e. a second compressor downstream of the heat exchanger and upstream of the turbine, wherein the second compressor receives the exhaust from the heat exchanger and provides a flow of exhaust to the turbine.

10. The power plant as in claim 9, wherein the second compressor provides the flow of exhaust to at least one cavity in the rotor.

11. The power plant as in claim 9, wherein the second compressor connects to at least one of the cavities through at least one stator.

12. The power plant as in claim 9, further comprising a control valve downstream of the second compressor and upstream of the turbine, wherein the control valve regulates the flow of exhaust to at least one cavity in the rotor.

13. The power plant as in claim 12, wherein the control valve regulates the flow of exhaust according to a pressure or a temperature.

14. The power plant as in claim 12, wherein the control valve regulates the flow of exhaust according to a power level of at least one of the first compressor or the turbine.

15. The power plant as in claim 9, wherein the flow of exhaust provided to the turbine from the second compressor has an oxygen content at least approximately 50% less than an oxygen content of the compressed working fluid.

16. The power plant as in claim 9, wherein the flow of exhaust provided to the turbine from the second compressor has an oxygen content at least approximately 75% less than an oxygen content of the compressed working fluid.

17. A method for controlling oxygen emissions from a gas turbine comprising:
a. flowing an exhaust from a turbine to a heat exchanger;
b. removing heat from the exhaust;
c. increasing the pressure of the exhaust to produce a pressurized exhaust; and
d. flowing the pressurized exhaust back to the turbine to remove heat from the turbine.

18. The method as in claim 17, further comprising flowing the pressurized exhaust to rotating components in the turbine.

19. The method as in claim 17, further comprising flowing the pressurized exhaust to stationary components in the turbine.

20. The method as in claim 17, further comprising controlling the flow of the pressurized exhaust to the turbine according to a power level of the gas turbine.
